(19) United States
(12) Patent Application Publication
(10) Pub. No.: US 2024/0177064 A1
(43) Pub. Date: May 30, 2024

(54) INFORMATION PROCESSING APPARATUS, STORAGE MEDIUM, AND OPTIMAL SOLUTION SEARCH METHOD

(71) Applicant: Tokyo Electron Limited, Tokyo (JP)

(72) Inventors: Satoshi ITOH, Yamanashi (JP); Hitoshi YONEMICHI, Sapporo City (JP)

(21) Appl. No.: 18/521,112

(22) Filed: Nov. 28, 2023

(30) Foreign Application Priority Data
Nov. 29, 2022 (JP) 2022-190481

(51) Int. Cl. G06N 20/00; G06N 5/04

(52) U.S. Cl. CPC G06N 20/00; G06N 5/04

(57) ABSTRACT

An information processing apparatus includes: a learning trainer configured to train a machine learning model to train a relationship between a process condition and a processing result of a substrate processing apparatus that has executed a processing based on the process condition; an inferrer configured to infer a plurality of processing results depending on a plurality of process conditions using the trained machine learning model; a graph creator configured to plot the plurality of processing results inferred with the machine learning model on a graph with an achievement level for a plurality of target values of the plurality of processing results as a plurality of axes; and an information display configured to display, on the graph, information used by an operator to select an optimal solution for the process condition, based on the plot of the plurality of inferred processing results.

### CROSS-REFERENCE TO RELATED APPLICATION

This application is based upon and claims the benefit of priority from Japanese Patent Application No. 2022-190481, filed on Nov. 29, 2022, the entire contents of which are incorporated herein by reference.

### TECHNICAL FIELD

The present disclosure relates to an information processing apparatus, a non-transitory computer-readable storage medium storing programs, and an optimal solution search method.

### BACKGROUND

In the related art, for example, techniques for searching process conditions that enable the acquisition of target process results using machine learning models of semiconductor manufacturing apparatuses have been known (see, e.g., Patent Document 1).

### PRIOR ART DOCUMENT

### Patent Document

Patent Document 1: Japanese Laid-Open Patent Publication No. 2022-119321

### SUMMARY

According to one embodiment of the present disclosure, an information processing apparatus includes: a learning trainer configured to train a machine learning model to learn a relationship between a process condition and a processing result of a substrate processing apparatus that has executed a processing based on the process condition; an inferrer configured to infer a plurality of processing results depending on a plurality of process conditions using the trained machine learning model; a graph creator configured to plot the plurality of processing results inferred with the machine learning model on a graph with an achievement level for a plurality of target values of the plurality of processing results as a plurality of axes; and an information display configured to display, on the graph, information used by an operator to select an optimal solution for the process condition, based on the plot of the plurality of inferred processing results.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a diagram illustrating an example of a configuration of an information processing system according to the present embodiment.

FIG. 2 is a diagram illustrating an example of a hardware configuration of a computer.

FIG. 3 is a functional block diagram illustrating an example of an information processing apparatus according to the present embodiment.

FIG. 4 is an image diagram illustrating an example of a plurality of measurement positions on a substrate on which a film formation is executed by a substrate processing apparatus.

FIGS. 5A and 5B are diagrams illustrating an example of an in-plane uniformity and an inter-plane uniformity of film thickness.

FIG. 6 is a flowchart of an example of processing of the information processing system according to the present embodiment.

FIG. 7 is a diagram illustrating an example of experimental results.

FIG. 8 is a flowchart illustrating an example of processing for the creation and display of a graph.

FIG. 9 is an image diagram illustrating an example of a graph on which inferred results are plotted.

FIG. 10 is an image diagram illustrating an example of a graph on which an apparatus-limit curve is displayed.

FIG. 11 is an image diagram illustrating an example of a graph on which an optimal solution plot is identifiably displayed.

### DETAILED DESCRIPTION

Hereinafter, non-limiting exemplary embodiments of the present disclosure will be described with reference to the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### System Configuration

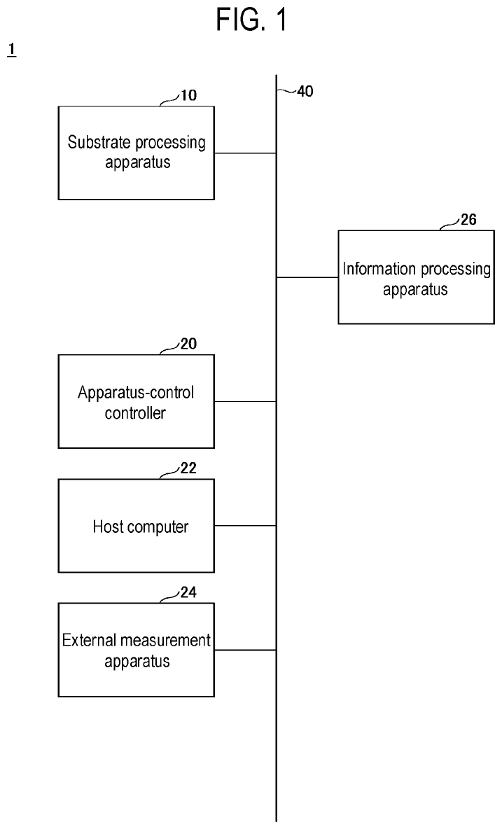

FIG. 1 is a diagram illustrating an example of a configuration of an information processing system according to the present embodiment. An information processing system 1 in FIG. 1 includes a substrate processing apparatus 10, an apparatus-control controller 20, a host computer 22, an external measurement apparatus 24, and an information processing apparatus 26.

The substrate processing apparatus 10, the apparatus-control controller 20, the host computer 22, the external measurement apparatus 24, and the information processing apparatus 26 are connected to each other in a communicable relationship with each other via a network 40 such as a local area network (LAN).

The substrate processing apparatus 10 is, for example, a film forming apparatus. The substrate processing apparatus 10 executes a processing corresponding to each operation (such as film formation, etching, ashing, cleaning or the like) of a substrate manufacturing process in response to control commands (process conditions) output from the apparatus-control controller 20.

The process conditions refer to conditions of the substrate manufacturing process. The process conditions are combinations of parameters that control (adjust) a control object (control knob) of the substrate processing apparatus 10. There are many different combinations of parameters to adjust the control knob. The substrate processing apparatus 10 is of, for example, a batch type or single wafer type.

The apparatus-control controller 20 is a controller having a computer configuration for controlling the substrate processing apparatus 10. The apparatus-control controller 20 outputs the process conditions to the substrate processing apparatus 10 as the parameters to adjust the control knob of the substrate processing apparatus 10.

The host computer 22 is an example of a man-machine interface (MMI) that accepts instructions for the substrate processing apparatus 10 from an operator and displays information about the substrate processing apparatus 10 to provide the same to the operator.

The external measurement apparatus 24 is a measurer that measures the results of a processing executed by the substrate processing apparatus 10 based on the process conditions, such as a film thickness measurer, a sheet resistance measurer, a particle measurer or the like. For example, the external measurement apparatus 24 measures, as an example of the processing results, a provision state of a film (film thickness) on a substrate such as a wafer processed by the substrate processing apparatus 10 based on the process conditions. The processing results may include refractive index, impurity concentration, roughness, electrical characteristic results (resistivity), and the like.

The information processing apparatus 26, as described later, trains a machine learning model to learn a relationship between the process conditions and processing results of the substrate processing apparatus 10 that has executed a processing based on the process conditions. The information processing apparatus 26 uses the trained machine learning model to infer a plurality of processing results depending on a plurality of process conditions. Further, the information processing apparatus 26 plots the plurality of processing results inferred with the trained machine learning model on a graph to be described later. Further, the information processing apparatus 26, as described later, displays information that the operator uses to select an optimal solution for the process conditions from the graph.

The operator selects the optimal solution for the process conditions from the graph displayed by the information processing apparatus 26 and instructs the substrate processing apparatus 10 to execute a processing based on the process conditions of the selected optimal solution. After executing the substrate processing apparatus 10 based on the process conditions, the operator measures the processing results of the substrate processing apparatus 10 using the external measurement apparatus 24 and provides a feedback to the information processing apparatus 26.

The information processing apparatus 26 repeatedly trains the machine learning model to re-learn a relationship between the process conditions of the selected optimal solution and the processing results of the substrate processing apparatus 10 that has executed a processing based on the process conditions, thereby improving the inference accuracy of the machine learning model.

In addition, the information processing system 1 in FIG. 1 is merely one example. There may be various system configuration examples depending on the intended use or the purpose thereof. The classification of apparatuses such as the substrate processing apparatus 10, the apparatus-control controller 20, the host computer 22, the external measurement apparatus 24, and the information processing apparatus 26 illustrated in FIG. 1 is merely one example.

For example, the information processing system 1 may have various configurations, including a configuration in which at least two of the substrate processing apparatus 10, the apparatus-control controller 20, the host computer 22, the external measurement apparatus 24, and the information processing apparatus 26 are integrated with each other, a configuration in which these components are further segmented, and the like.

### Hardware Configuration

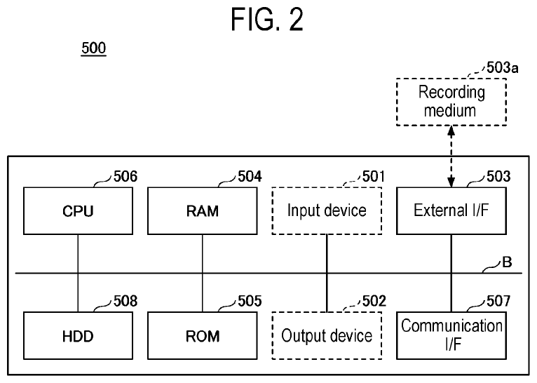

The apparatus-control controller 20, the host computer 22, and the information processing apparatus 26 of the information processing system 1 are implemented by a computer 500 with, for example, a hardware configuration of FIG. 2. FIG. 2 is a diagram illustrating an example of the hardware configuration of the computer 500.

The computer 500 in FIG. 2 includes components such as an input device 501, an output device 502, an external interface (I/F) 503, a random access memory (RAM) 504, a read only memory (ROM) 505, a central processing unit (CPU) 506, a communication I/F 507, and a hard disk drive (HDD) 508, all of which are interconnected via a bus. In addition, the input device 501 and the output device 502 may be connected and used as needed.

The input device 501 includes devices such as a keyboard, a mouse, and a touch panel, which are used by the operator and the like to input each operational signal. The output device 502 is a display or similar device used to display the processing results of the computer 500. The communication I/F 507 is an interface that connects the computer 500 to the network 40. The HDD 508 is an example of a non-volatile storage device used to store programs and data.

The external I/F 503 is an interface to an external device. The computer 500 may perform reading from and/or writing to a recording medium 503a such as a secure digital (SD) memory card via the external I/F 503. The ROM 505 is an example of a non-volatile semiconductor memory (storage device) in which programs and data are stored. The RAM 504 is an example of a volatile semiconductor memory (storage device) used to temporarily hold programs and data.

The CPU 506 is an operational device that reads programs and data from storage devices such as the ROM 505 and the HDD 508 onto the RAM 504 and executes a processing to implement the overall control and functions of the computer 500.

The apparatus-control controller 20, the host computer 22, and the information processing apparatus 26 as illustrated in FIG. 1 may implement various functions as described later, for example, by executing programs with the computer 500 having the hardware configuration of FIG. 2.

### Functional Configuration

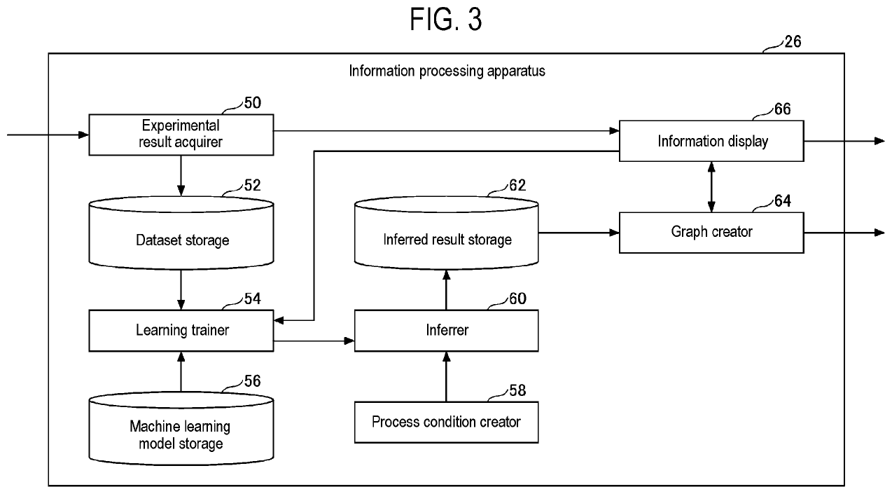

The information processing apparatus 26 of the information processing system 1 according to the present embodiment is implemented by functional blocks as illustrated in FIG. 3, for example. FIG. 3 is a functional block diagram illustrating an example of the information processing apparatus according to the present embodiment. In addition, in the functional block diagram of FIG. 3, illustration of unnecessary components for the description of the present embodiment is omitted.

The information processing apparatus 26 executes programs, and implements an experimental result acquirer 50, a dataset storage 52, a learning trainer 54, a machine learning model storage 56, a process condition creator 58, an inferrer 60, an inferred result storage 62, a graph creator 64, and an information display 66.

The experimental result acquirer 50 acquires, as experimental results, a relationship between the process conditions and the processing results of the substrate processing apparatus 10 that has executed a processing based on the process conditions. The dataset storage 52 stores, as a dataset, the experimental results acquired by the experimental result acquirer 50. For example, the experimental results associate the process conditions with the measured values of film thickness at a plurality of measurement positions of a substrate on which a film formation has executed by the substrate processing apparatus 10 based on the process conditions.

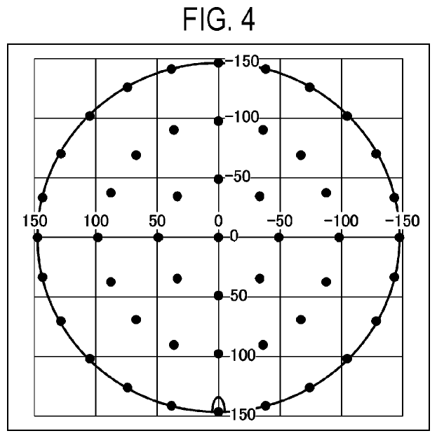

FIG. 4 is an image diagram illustrating an example of the plurality of measurement positions on a substrate on which the film formation is executed by the substrate processing apparatus. FIG. 4 illustrates 49 measurement positions on the substrate. The external measurement apparatus 24 measures, for example, the film thickness at 49 measurement positions on the substrate in FIG. 4.

For example, the dataset stored in the dataset storage 52 is prepared by instructing the substrate processing apparatus 10 to execute a processing under a plurality of process conditions based on, for example, an experimental design method, and collecting data about the processing results for the processing executed based on each process condition.

The learning trainer 54 trains the machine learning model to learn a relationship between the process conditions stored as the dataset by the dataset storage 52 and the processing results of the substrate processing apparatus 10 that has executed a processing based on the process conditions. The machine learning model storage 56 stores the machine learning model to be trained by the learning trainer 54. The machine learning model stored in the machine learning model storage 56 is, for example, a machine learning model using a regression method such as linear regression or nonlinear regression.

The process condition creator 58 comprehensively creates a plurality of process conditions to be inferred by the inferrer 60. The inferrer 60 uses the trained machine learning model to infer a plurality of processing results depending on the plurality of process conditions. The inferred result storage 62 stores, as the inferred results, a relationship between the process conditions and the processing results inferred by the inferrer 60.

The graph creator 64 plots the processing results inferred by the inferrer 60 on the graph with a plurality of axes representing achievement levels for a plurality of target values of the processing results. An example of the plurality of target values of the processing results is the in-plane uniformity and inter-plane uniformity of film thickness. For example, the graph creator 64 plots the plurality of processing results depending on the plurality of process conditions inferred by the inferrer 60 on the graph with the in-plane uniformity and inter-plane uniformity of film thickness as axes. For example, the plotted content is provided to the operator via the output device 502.

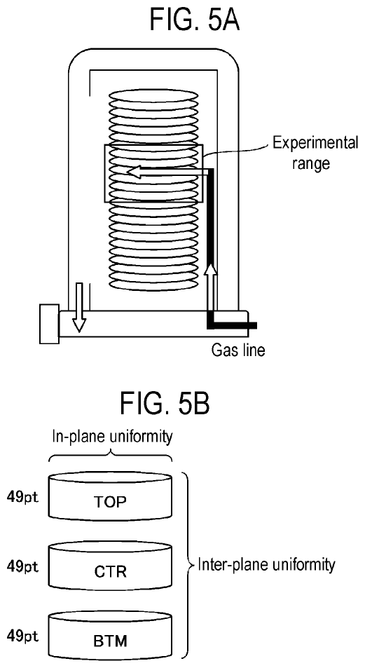

Here, the in-plane uniformity and inter-plane uniformity of film thickness will be described. FIGS. 5A and 5B are diagrams illustrating an example of the in-plane uniformity and inter-plane uniformity of film thickness. FIGS. 5A and 5B illustrate an example in which the substrate processing apparatus 10 is of a batch type. FIG. 5A is a schematic diagram illustrating an example of the batch-type substrate processing apparatus 10. The batch-type substrate processing apparatus 10 is configured to arrange a plurality of substrates in the vertical direction within a batch furnace, and to execute the film formation based on the process conditions. FIG. 5A illustrates some of the plurality of substrates arranged in the vertical direction within the batch furnace as an experimental range.

Further, FIG. 5B illustrates a top substrate TOP, a bottom substrate BTM, and a substrate CTR between the top substrate TOP and the bottom substrate BTM within the experimental range illustrated in FIG. 5A. The in-plane uniformity of film thickness refers to the uniformity of film thickness at a plurality of measurement positions in one substrate. For example, in FIG. 5B, the uniformity of film thickness at 49 measurement positions in the top substrate TOP, the uniformity of film thickness at 49 measurement positions in the substrate CTR, and the uniformity of the film thickness at 49 measurement positions in the bottom substrate BTM are the in-plane uniformity. The in-plane uniformity of film thickness is a value that indicates the uniformity of film formation in the substrate, such as a numerical value calculated by dividing the difference between the maximum and minimum values of film thickness at 49 measurement positions in the substrate by the average value.

Further, the inter-plane uniformity of film thickness refers to the uniformity of film thickness at a plurality of measurement positions between a plurality of substrates. For example, in FIG. 5B, the uniformity of film thickness at measurement positions of the top substrate TOP, the substrate CTR, and the bottom substrate BTM is the inter-plane uniformity. The inter-plane uniformity of film thickness is a value that indicates the uniformity of film formation between substrates, such as a numerical value calculated by dividing the difference between the maximum and minimum values and the average value of film thickness at each of the 49 measurement positions in the top substrate TOP, 49 measurement positions in the substrate CTR, and 49 measurement positions in the bottom substrate BTM by the average value.

The information display 66 graphically displays information, which is used by the operator to select an optimal solution for the process conditions, based on graph plots. An example of the information used by the operator to select the optimal solution for the process conditions is information indicating the limit (apparatus-limit) of the substrate processing apparatus 10 in terms of achievement levels for a plurality of target values of the processing results predicted based on the graph plots. The apparatus-limit of the substrate processing apparatus 10 is information indicating achievement levels for a plurality of target values of the processing results that may not be achieved even if the operator adjusts the process conditions.

For example, in the graph with the in-plane uniformity and inter-plane uniformity of film thickness as axes, the information indicating the limit of the substrate processing apparatus 10 in terms of achievement levels of a plurality of target values of the processing results is information that indicates the limit of the in-plane uniformity and inter-plane uniformity of film thickness that may not be reached even if the operator adjusts the process conditions.

Further, an example of the information used by the operator to select the optimal solution for the process conditions may be information indicating, among the graph plots, the plot with the highest achievement level for a plurality of target values of the processing results.

The operator selects the process conditions to instruct the substrate processing apparatus 10 to execute a processing with reference to the information used to select the optimal solution for the process conditions displayed in the graph. Subsequently, the operator instructs the substrate processing apparatus 10 to execute a processing based on the process conditions of the selected optimal solution. The operator uses the external measurement apparatus 24 to measure the processing results after the execution of the processing based on the process conditions, and provides a feedback to the information processing apparatus 26. The feedback to the information processing apparatus 26 may be provided from the external measurement apparatus 24 via the network 40, or may be provided via a recording medium such as a universal serial bus (USB) memory.

The information processing apparatus 26 may determine whether to continue or terminate search of the optimal solution for the process conditions based on the feedback, as described later. Further, the information processing apparatus 26 may display information to allow the operator to determine whether to continue or terminate the search of the optimal solution for the process conditions based on the feedback.

### Processing

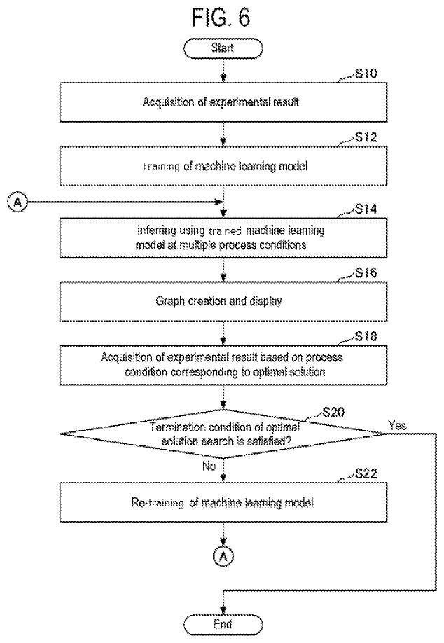

Hereinafter, an example of the search of the optimal solution for the process conditions to optimize the in-plane uniformity and inter-plane uniformity in the substrate will be described. FIG. 6 is a flowchart illustrating an example of processing performed by the information processing system according to the present embodiment.

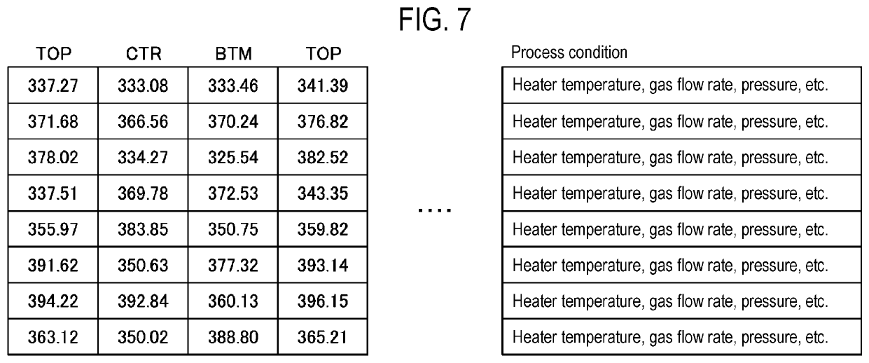

For example, the operator instructs the substrate processing apparatus 10 to execute a film formation processing, and collects data about the measured values of the film formation results when the film formation processing has been executed based on each process condition, while varying the process conditions based on, e.g., the experimental design method. The operator prepares the experimental results as illustrated in FIG. 7 that associate the process conditions with the measured values of film thickness at a plurality of measurement positions of the substrate on which the film formation processing has been performed based on the process conditions.

FIG. 7 is a diagram illustrating an example of experimental results. The experimental results illustrated in FIG. 7 are information that associate the process conditions with the measured values of film thickness at 147 points (49 points×3 sheets) for 49 measurement positions of the substrates TOP, CTR and BTM on which the film formation processing has been executed based on the process conditions. The process conditions include parameters such as heater temperature, gas flow rate, and pressure. For example, the experimental results in FIG. 7 represent 8 sets by way of example, but are not limited to 8 sets.

In step S10, the experimental result acquirer 50 of the information processing apparatus 26 acquires, for example, the experimental results in FIG. 7, so that the dataset storage 52 stores the acquired experimental results.

In step S12, the learning trainer 54 trains the machine learning model for each of the 147 measurement positions stored in the machine learning model storage 56 to learn the experimental results in FIG. 7 stored as a dataset in the dataset storage 52. The learning trainer 54 trains the machine learning model to learn a relationship between the process conditions and the measured values of film thickness when the film formation processing has been executed based on the process conditions, with the use of the measured values of film thickness at the 147 points in FIG. 7 as objective variables and the process conditions as explanatory variables.

In step S14, the process condition creator 58 comprehensively creates a plurality of process conditions (for example, 50 sets) for inference by the machine learning model trained by the learning trainer 54. The inferrer 60 uses the trained machine learning model to infer film formation results depending on the plurality of process conditions created by the process condition creator 58. The inferred result storage 62 stores, as the inferred results of the inferrer 60, a relationship between the process conditions and the predicted values of film thickness for each of the 147 measurement positions when the film formation processing has been executed based on the process conditions in the inferred result storage 62.

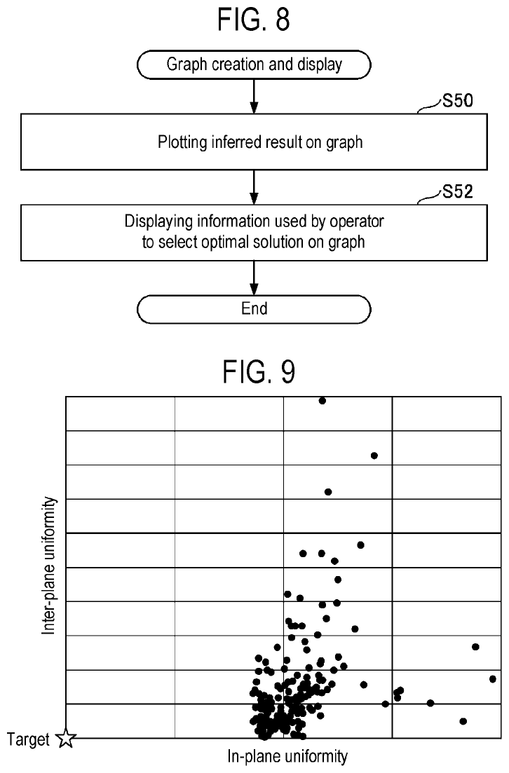

In step S16, the graph creator 64 and the information display 66 create and display a graph using the inferred results stored in the inferred result storage 62. The creation and display of the graph in step S16 are executed, for example, in the order illustrated in FIG. 8.

FIG. 8 is a flowchart illustrating an example of processing for the creation and display of the graph. In step S50, the graph creator 64 calculates the in-plane uniformity and inter-plane uniformity of film thickness for each process condition from the inferred results stored in the inferred result storage 62. The graph creator 64 uses the calculated in-plane uniformity and inter-plane uniformity of film thickness for each process condition to plot the inferred results on the graph in FIG. 9, for example. In the present embodiment, the use of the trained machine learning model allows for increasing the number of plots on the graph without increasing the number of experiments.

FIG. 9 is an image diagram illustrating an example of the graph on which the inferred results are plotted. The graph illustrated in FIG. 9 is an example of the graph with the in-plane uniformity and inter-plane uniformity of film thickness as axes. The graph in FIG. 9 represents the film formation results inferred by the inferrer 60 on the graph with achievement levels for a target value of the in-plane uniformity and inter-plane uniformity of film thickness as axes. In the graph illustrated in FIG. 9, the target value is represented by the asterisk at the left bottom. Each plot in FIG. 9 represents the film formation results inferred for each process condition.

However, the in-plane uniformity and inter-plane uniformity of film thickness has the apparatus-limit of the substrate processing apparatus 10 that may not be achieved even if the operator adjusts the process conditions. Referring to the graph in FIG. 9, the operator may predict the apparatus-limit, which assists in avoiding unnecessary optimal solution search beyond the apparatus-limit.

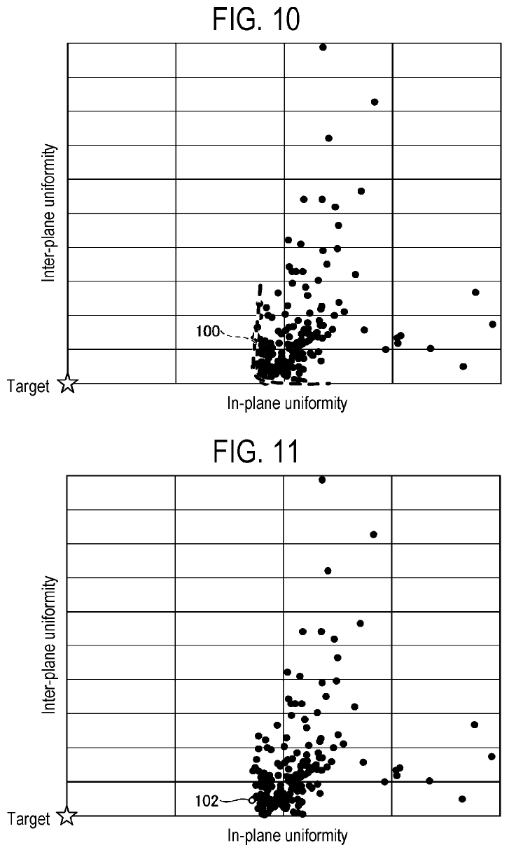

In step S52, the information display 66 graphically displays information, which is used by the operator to select the optimal solution for the process conditions, based on graph plots in FIG. 9. For example, the information display 66 graphically displays, in an apparatus-limit curve 100 as illustrated in FIG. 10, the apparatus-limit of the substrate processing apparatus 10 in terms of the in-plane uniformity and inter-plane uniformity of film thickness that may be achieved by adjusting the process conditions. FIG. 10 is an image diagram illustrating an example of a graph on which an apparatus-limit curve is displayed.

By referring to the apparatus-limit curve 100 in FIG. 10, the operator may determine whether or not hardware replacement (improvement) of the substrate processing apparatus 10 is necessary to bring the in-plane uniformity and inter-plane uniformity of film thickness closer to a target with reference to an objectively illustrated apparatus-limit of the substrate processing apparatus 10 in terms of the in-plane uniformity and inter-plane uniformity of film thickness. Further, the operator may use the objectively illustrated apparatus-limit of the substrate processing apparatus 10 in terms of the in-plane uniformity and inter-plane uniformity of film thickness as the endpoint of optimal solution search.

The apparatus-limit curve 100 in FIG. 10 is merely one example. For example, the information display 66 may select an optimal solution plot 102 based on the apparatus-limit of the substrate processing apparatus 10 in terms of the in-plane uniformity and inter-plane uniformity of film thickness that may be achieved by adjusting the process conditions as well as the plot positions on the graph, and may identifiably display the selected plot as illustrated in the graph of FIG. 11. FIG. 11 is an image diagram illustrating an example of the graph on which the optimal solution plot is identifiably displayed. In addition, the apparatus-limit curve 100 in FIG. 10 and the optimal solution plot 102 may be displayed on the same graph.

Returning to step S18 in FIG. 6, the operator selects the optimal solution plot from the plots illustrated in the graphs of FIGS. 9 to 11, instructs the substrate processing apparatus 10 to execute a film formation processing based on the process conditions corresponding to the selected plot, and collects the measured values data of the film formation results. The experimental result acquirer 50 of the information processing apparatus 26 acquires the experimental results in step S18. In step S20, the graph creator 64 and the information display 66 use the experimental results to calculate the in-plane uniformity and inter-plane uniformity of film thickness and determine whether or not a termination condition of the optimal solution search is satisfied.

For example, the information display 66 determines that the termination condition of optimal solution search is satisfied when, for example, the distance between the plot of the experimental results in step S18 and the apparatus-limit curve 100 is not more than a threshold and/or when the distance from a target is not more than a threshold. Further, the termination condition of the optimal solution search may include a condition in which the difference between the predicted values of the film formation results and the measured values is not more than a threshold.

When it is determined that the termination condition of the optimal solution search is not satisfied, the learning trainer 54 performs the re-learning of the machine learning model with a dataset to which the experimental results in step S18 have been added, and returns to the processing of step S14. By repeating the processing of steps S14 to S22, the inference accuracy of the machine learning model is improved.

When it is determined that the termination condition of the optimal solution search is satisfied, the information processing apparatus 26 terminates the processing illustrated in the flowchart of FIG. 6. In addition, when the number of repetitions of steps S14 to S22 exceeds a predetermined number, the information processing apparatus 26 may determine that the optimal solution search has failed and may terminate the processing illustrated in the flowchart of FIG. 6.

Further, the operator may predict that there may be some issues with the hardware of the substrate processing apparatus 10 by comparing the apparatus-limit curve 100 of the substrate processing apparatus 10 in FIG. 10 with the apparatus-limit curve 100 of another substrate processing apparatus 10 of the same type or in the past. Further, although the in-plane uniformity and inter-plane uniformity of film thickness are likely to be trade-off, it is easy for the operator to search for the optimal solution for the process conditions (so-called Pareto solution) that simultaneously optimizes both the in-plane uniformity and the inter-plane uniformity of film thickness.

In addition, in the present embodiment, an example of the graph with the in-plane uniformity and inter-plane uniformity of film thickness as axes has been described, but a two-dimensional or higher-dimensional graph with other items as axes may also be used. The items on the graph axes may be values calculated from the measured values of the substrate processed based on the process conditions.

For example, when the substrate processing apparatus 10 is of a single wafer type, the graph creator 64 may create a two-dimensional graph with the in-plane uniformity of film thickness and the uniformity of film thickness between slots as axes. The graph creator 64 may also create a two-dimensional or higher-dimensional graph with axes representing items such as refractive index, impurity concentration, roughness, or electrical characteristic results (resistivity), in addition to the uniformity of film thickness.

According to the present embodiment, it is possible to reduce the number of experiments required for the operator to search for the optimal solution for the process conditions to be executed by the substrate processing apparatus 10, and to assist in reducing wafer costs and running costs.

According to the present disclosure in some embodiments, it is possible to assist in optimal solution search for process conditions to be executed by a substrate processing apparatus.

Each embodiment disclosed herein should be considered to be exemplary and not limitative in all respects. Each embodiment described above may be omitted, replaced or modified in various embodiments without departing from the scope of the appended claims and their gist.

What is claimed is:

1. An information processing apparatus comprising:
a learning trainer configured to train a machine learning model to learn a relationship between a process condition and a processing result of a substrate processing apparatus that has executed a processing based on the process condition;
an inferrer configured to infer a plurality of processing results depending on a plurality of process conditions using the trained machine learning model;
a graph creator configured to plot the plurality of processing results inferred with the machine learning model on a graph with an achievement level for a plurality of target values of the plurality of processing results as a plurality of axes; and
an information display configured to display, on the graph, information used by an operator to select an optimal solution for the process condition, based on the plot of the plurality of inferred processing results.

2. The information processing apparatus of claim 1, wherein the information display displays, on the graph, a limit of the substrate processing apparatus in terms of the achievement level for the plurality of target values of the plurality of processing results predicted based on the plot.

3. The information processing apparatus of claim 2, wherein the information display displays, on the graph, information on the optimal solution which is selected based on the plot displayed on the graph and the limit of the substrate processing apparatus in terms of the achievement level for the plurality of target values of the plurality of processing results.

4. The information processing apparatus of claim 3, wherein the learning trainer retrains the machine learning model to relearn a relationship between the process condition of the optimal solution and the processing result of the substrate processing apparatus when a distance in the graph between the processing result of the substrate processing apparatus that has executed the processing based on the process condition of the optimal solution and the processing result depending on the process condition of the optimal solution inferred with the trained machine learning model is not within a threshold, and
wherein the graph creator updates the plot of the graph with the plurality of processing results inferred with the retrained machine learning model.

5. The information processing apparatus of claim 3, wherein the graph creator plots the plurality of processing results inferred with the machine learning model on the graph with values calculated from a plurality of measured values of a substrate processed by the substrate processing apparatus based on the process condition as axes.

6. The information processing apparatus of claim 3, wherein the graph creator plots the plurality of processing results inferred with the machine learning model on the graph with an in-plane uniformity and an inter-plane uniformity of a substrate processed by the substrate processing apparatus based on the process condition as axes.

7. The information processing apparatus of claim 3, wherein the substrate processing apparatus is of a batch type or single wafer type.

8. The information processing apparatus of claim 2, wherein the learning trainer retrains the machine learning model to relearn a relationship between the process condition of the optimal solution and the processing result of the substrate processing apparatus when a distance in the graph between the processing result of the substrate processing apparatus that has executed the processing based on the process condition of the optimal solution and the processing result depending on the process condition of the optimal solution inferred with the trained machine learning model is not within a threshold, and
wherein the graph creator updates the plot of the graph with the plurality of processing results inferred with the retrained machine learning model.

9. The information processing apparatus of claim 2, wherein the graph creator plots the plurality of processing results inferred with the machine learning model on the graph with values calculated from a plurality of measured values of a substrate processed by the substrate processing apparatus based on the process condition as axes.

10. The information processing apparatus of claim 2, wherein the graph creator plots the plurality of processing results inferred with the machine learning model on the graph with an in-plane uniformity and an inter-plane uniformity of a substrate processed by the substrate processing apparatus based on the process condition as axes.

11. The information processing apparatus of claim 2, wherein the substrate processing apparatus is of a batch type or single wafer type.

12. A non-transitory computer-readable storage medium storing a program that causes an information processing apparatus to execute a process comprising:
training a machine learning model to learn a relationship between a process condition and a processing result of a substrate processing apparatus that has executed a processing based on the process condition;
inferring a plurality of processing results depending on a plurality of process conditions using the trained machine learning model;
plotting the plurality of processing results inferred with the machine learning model on a graph with an achievement level for a plurality of target values of the plurality of processing results as a plurality of axes; and
displaying, on the graph, information used by an operator to select an optimal solution for the process condition, based on the plot of the plurality of inferred processing results.

13. An optimal solution search method executed by an information processing apparatus, the optimal solution search method comprising
training a machine learning model to learn a relationship between a process condition and a processing result of a substrate processing apparatus that has executed a processing based on the process condition;
inferring a plurality of processing results depending on a plurality of process conditions using the trained machine learning model;
plotting the plurality of processing results inferred with the machine learning model on a graph with an achievement level for a plurality of target values of the plurality of processing results as a plurality of axes; and
displaying, on the graph, information used by an operator to select an optimal solution for the process condition, based on the plot of the plurality of inferred processing results.
